(19) United States
(12) Patent Application Publication
(10) Pub. No.: US 2026/0249461 A1
(43) Pub. Date: Aug. 27, 2026

(54) TEACHING DEVICE

(71) Applicant: FANUC CORPORATION, Yamanashi (JP)

(72) Inventors: Kunihiko HARADA, Yamanashi (JP); Yuelai WANG, Yamanashi (JP); Yasuhiro NAITOU, Yamanashi (JP)

(21) Appl. No.: 18/992,980

(22) PCT Filed: Aug. 24, 2022
(86) PCT No.: PCT/JP2022/031928

§ 371 Date: Jan. 10, 2025

(51) Int. Cl. B25J 9/16; B25J 13/06

(52) U.S. Cl. CPC B25J 9/1666; B25J 9/161; B25J 9/163; B25J 9/1653; B25J 9/1671; B25J 13/06

(57) ABSTRACT

A teaching device for teaching a robot includes: a storage unit that stores mechanism data for finding a relationship between a tip position of a robot and an angle position at a joint portion of the robot, the mechanism data including a mechanism error parameter of an actual robot; and a virtual robot control unit that controls the operation of a virtual robot on the basis of the mechanism data such that an error in position that occurs in the actual robot due to the mechanism error parameter occurs in the virtual robot.

### FIELD

The present invention relates to a teaching device for performing off-line teaching of a robot.

### BACKGROUND

A teaching device that arranges a three-dimensional model of a robot, a workpiece, a peripheral device, and the like on a virtual space, and performs off-line teaching of a robot motion is widely used. For example, PTL 1 describes a system including a dimension-variable three-dimensional model creation unit 71 that creates a dimension-variable three-dimensional model of a workpiece, a measurement unit 5 that measures a position, a posture, and dimensions of an actual workpiece, a three-dimensional model revision unit 72 that revises a three-dimensional model based on a measurement result, and an off-line teaching unit 73 that performs teaching of a robot motion off-line based on the revised three-dimensional model (abstract).

Unlike a virtual robot in off-line teaching, an actual robot may have an error between a command position and a position being actually reached by the actual robot due to a manufacturing error and the like. Thus, mechanism data including a manufacturing error and the like are calibrated in such a way that the position being actually reached by the actual robot is set as close to the command position as possible so that accuracy of an absolute position of the actual robot is improved. With regard to this, PTL 2 describes as follows: “Conventionally, when a mechanism parameter is updated, a motion program is subsequently executed by using the updated mechanism parameter, and therefore if a motion program taught before the update of mechanism parameter is executed as it is, a position and a posture of a tip of a robot at the time of the teaching cannot be achieved. According to the present aspect, a position and a posture of a tip of a robot at the time of the teaching can be achieved even when a motion program taught to the robot before the update of mechanism parameter is executed using a current mechanism parameter by correcting position data of the motion program by using a mechanism parameter before the update and the current mechanism parameter. As a result, a motion program taught to the robot by teaching work before execution of calibration can be reused without performing re-teaching work” (paragraph 0009).

### CITATION LIST

### Patent Literature

[PTL 1] Japanese Unexamined Patent Publication (Kokai) No. H11-296218 A
[PTL 2] Japanese Patent No. 6453918 B

### SUMMARY

### Technical Problem

Conventionally, it is general that in off-line teaching, a three-dimensional model of a robot according to a design value (i.e., not including an error) is used as a virtual robot. If a three-dimensional model of a robot not including an error is used in off-line teaching, a positional error may be caused between a position reached by an actual robot and the position of the three-dimensional model of a robot. Such an issue may be solved by an approach of performing off-line teaching by measuring actual dimensions of a robot by a measurement and revising a three-dimensional model of the robot. However, a robot includes a connection portion between links and the like, and it is difficult to measure, for example, a distance between link rotational centers by a measurement in a detailed and accurate manner.

An object of the present invention is to provide a teaching device that can improve accuracy of teaching using such a virtual robot.

### Solution to Problem

One aspect of the present disclosure is a teaching device for performing teaching of a robot, and the teaching device includes: a storage unit configured to store mechanism data being used for obtaining a relationship between an angle position in a joint portion of a robot and a tip position of the robot and including a mechanism error parameter of an actual robot; and a virtual robot control unit configured to control a motion of a virtual robot, based on the mechanism data, in such a way that an error of a position occurring in the actual robot by the mechanism error parameter is caused in the virtual robot. Another aspect of the present disclosure is a teaching device for performing teaching of a robot, and the teaching device includes: a storage unit configured to store mechanism data being used for obtaining a relationship between an angle position in a joint portion of a robot and a tip position of the robot and including a mechanism error parameter of an actual robot, and to store a motion program; a conversion unit configured to convert position data in the motion program in such a way that, in a case where the mechanism data are not applied to an actual robot, the actual robot reaches the same position as a position reached when the mechanism data are applied, or in such a way that, in a case where the mechanism data are applied to an actual robot, the actual robot reaches the same position as a position reached when the mechanism data are not applied; and an association unit configured to estimate data needed for conversion of the position data, and associate the data with the position data for the conversion.

### Advantageous Effects of Invention

According to the configuration described above, accuracy of teaching using a virtual robot can be improved.

The objects, the features, and the advantages, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating a calibration system according to a first embodiment and an off-line teaching device that performs teaching off-line.

FIG. 2 is a diagram illustrating a configuration of a robot.

FIG. 3 is a flowchart illustrating collection processing of a command position and a measurement position.

FIG. 4 is a diagram illustrating an error due to bending of an arm of a robot by gravity.

FIG. 5 is a diagram illustrating an error due to a twist between axes of a robot.

FIG. 6 is a diagram illustrating an angular transfer error.

FIG. 7 is a functional block diagram of the off-line teaching device according to the first embodiment.

FIG. 8 is a diagram illustrating an example of a UI screen by a mechanism data reading unit.

FIG. 9 is a functional block diagram of a program conversion device according to a second embodiment.

FIG. 10 is a diagram illustrating an example of a UI screen for selecting a program to be converted.

FIG. 11 is a diagram illustrating an example of a UI screen related to detailed setting of conversion.

FIG. 12 is a diagram illustrating correction of a position of a robot based on mechanism data.

FIG. 13 is a functional block diagram of a program conversion device according to a third embodiment.

FIG. 14 is a functional block diagram of an off-line teaching device according to a fourth embodiment.

FIG. 15 is a functional block diagram of a program conversion device according to a fifth embodiment.

FIG. 16 is a functional block diagram of an off-line teaching device according to a sixth embodiment.

FIG. 17A is a diagram illustrating a first function of conversion of position data by the off-line teaching device according to the sixth embodiment.

FIG. 17B is a diagram illustrating a second function of conversion of position data by the off-line teaching device according to the sixth embodiment.

FIG. 18 is a functional block diagram of an off-line teaching device according to a seventh embodiment.

FIG. 19 is a diagram illustrating a layout revision function by the off-line teaching device according to the seventh embodiment.

FIG. 20 is a functional block diagram of an off-line teaching device off-line according to an eighth embodiment.

### DESCRIPTION OF EMBODIMENTS

Next, embodiments of the present disclosure will be described with reference to drawings. A similar configuration portion or a similar functional portion is denoted by the same reference sign in the referred drawings. A scale is appropriately changed in the drawings in order to facilitate understanding. An aspect illustrated in the drawing is one example for implementing the present invention, and the present invention is not limited to the illustrated aspect.

### First Embodiment

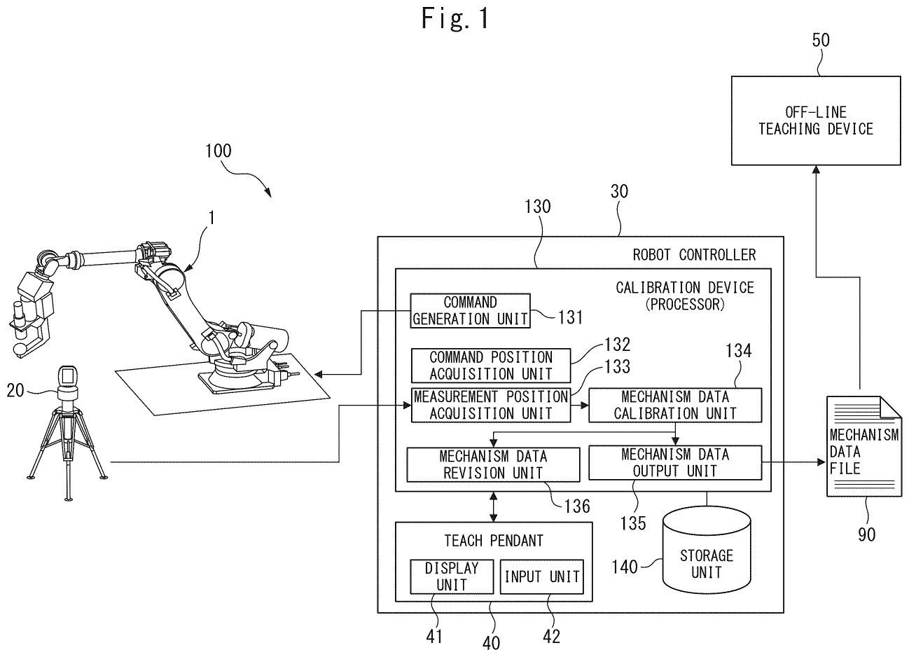

FIG. 1 is a diagram illustrating a calibration system 100 according to an embodiment and an off-line teaching device 50 that performs teaching off-line. An actual robot may have an error between a command position and a position being actually reached by the robot due to a processing error, an assembly error, and the like. The calibration system 100 can measure and output mechanism data including such processing error and assembly error (i.e., calibrate mechanism data). The off-line teaching device 50 is a device for performing teaching off-line using a virtual robot based on the mechanism data output from the calibration system 100. The off-line teaching device 50 can acquire the mechanism data calibrated by the calibration system 100, cause the virtual robot to perform a motion (simulation) in which an error occurring in an actual robot is reflected, and perform detailed and accurate teaching.

As illustrated in FIG. 1, the calibration system 100 includes a robot 1, a calibration device 130 that performs calibration of the robot 1, and a three-dimensional measuring instrument 20 for performing a three-dimensional position measurement of a target. The present embodiment indicates an example in which the calibration device 130 is configured as a function achieved by a processor in the robot controller 30 executing software. The three-dimensional measuring instrument 20 is a three-dimensional measuring instrument such as a laser tracker. As illustrated in FIG. 1, the robot controller 30 includes a teach pendant 40 having a function as an operation input device for operating the robot 1. The teach pendant 40 includes a display unit 41 and an input unit 42. The input unit 42 is a key input device, a touch panel input device, or the like. In a case of a touch panel input device, the display unit 41 and the input unit 42 are integrally formed. The display unit 41 includes, for example, a flat-panel display. The robot controller 30 includes a storage unit 140 (a ROM, a RAM, a non-volatile memory, or another storage device). The storage unit 140 stores various types of information needed for the calibration device 130 to operate, such as a motion program and mechanism data, for example.

In the present embodiment, the calibration device 130 is assumed to be a function implemented in the robot controller 30, but a configuration example in which the calibration device 130 is implemented in the off-line teaching device 50 is also possible.

In the present embodiment, the robot 1 is assumed to be a six-axis vertical articulated robot. It should be noted that a robot of various types such as a parallel link robot or a dual arm robot may be used as the robot 1 according to a work target. The robot 1 can perform desired work by using a work tool as an end effector attached to a wrist portion. The work tool is an external device exchangeable according to use, and is, for example, a hand, a welding gun, a tool, and the like. FIG. 1 illustrates an example in which a welding gun is used as a work tool.

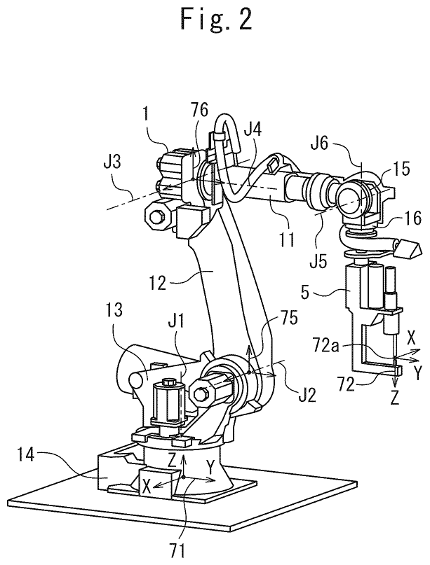

FIG. 2 illustrates a perspective view as a configuration example of the robot 1 according to the present embodiment. As illustrated in FIG. 2, the robot 1 includes a base 14, a turning base 13, a lower arm 12, an upper arm 11, a wrist 15, and a flange 16. The lower arm 12 is supported by the turning base 13. The turning base 13 is supported by the base 14. The wrist 15 is connected to an end portion of the upper arm 11. The wrist 15 includes the flange 16 that fixes a welding gun 5. Constituent members such as the upper arm 11 and the lower arm 12 are connected via a joint portion.

The robot 1 includes a driving motor arranged for each of the turning base 13, the upper arm 11, the lower arm 12, the wrist 15, and the flange 16. The welding gun 5 includes a tool driving device that drives the welding gun 5, a motor that drives a movable electrode, and the like.

An origin of a world coordinate system 71 is set in the base 14 of the robot 1. The world coordinate system 71 is immovable when a position and a posture of the robot 1 change, and is also referred to as a reference coordinate system. A tool coordinate system 72 having an origin set in any position of a work tool is set in the robot 1. The tool coordinate system 72 has a position and a posture changing together with the welding gun 5. In the present embodiment, the origin of the tool coordinate system 72 is set at a tool tip point 72a (tip point of a fixed electrode). As an example, in the present embodiment, a position of the robot 1 corresponds to a position of the tool tip point (a position of the origin of the tool coordinate system 72). Further, a posture of the robot 1 corresponds to a posture of the tool coordinate system 72 with respect to the world coordinate system 71.

FIG. 2 illustrates joint axes J1 to J6 in each joint portion. Angles D1 to D6 of the joint portion are determined in each of the joint axes J1 to J6. For example, an angle of the joint portion corresponds to an angle between constituent members in the joint portion. Further, an angle of the joint portion corresponds to a rotational position of a driving motor arranged in association with each joint portion.

As illustrated in FIG. 1, the calibration device 130 includes a command generation unit 131, a command position acquisition unit 132, a measurement position acquisition unit 133, a mechanism data calibration unit 134, a mechanism data output unit 135, and a mechanism data revision unit 136.

The command generation unit 131 generates a command for moving the robot 1 to any position. The robot controller 30 includes a servo control unit (not illustrated) that performs servo control of a motor of each axis of the robot 1 according to a command generated by the command generation unit 131.

The command position acquisition unit 132 acquires and stores a current command position output from the command generation unit 131. The current command position is stored in the storage unit 140, for example.

The measurement position acquisition unit 133 provides a measurement command to the three-dimensional measuring instrument 20, and acquires and stores three-dimensional position information about a measurement target (for example, the tool tip point 72a). The measured three-dimensional position information is stored in the storage unit 140, for example.

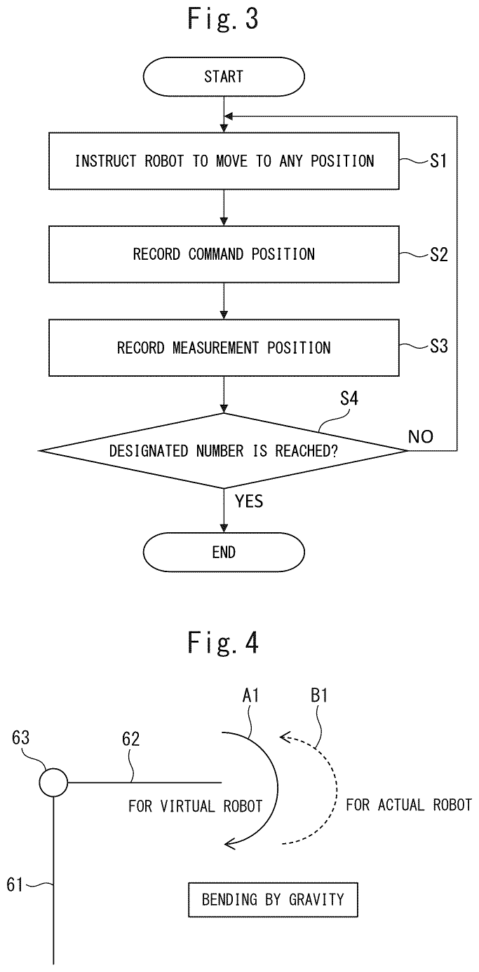

FIG. 3 illustrates a flowchart of collection processing of a command position and a measurement position of a robot. The collection processing is executed under control by the calibration device 130 (processor). The command generation unit 131 generates a command for moving the robot 1 to any position, and causes the robot 1 to perform a motion (step S1). Next, the command position acquisition unit 132 records a command position for the robot 1 (step S2). Next, the measurement position acquisition unit 133 records a position of the robot 1 (for example, a position of the tool tip point 72a) measured by the three-dimensional measuring instrument 20 (step S3). The calibration device 130 executes the processing from steps S1 to S3 until a designated number is reached (step S4: NO). It should be noted that the designated number is a number for acquiring data (command position, measurement position) sufficient to perform identification calculation of mechanism data. When the processing from steps S1 to S3 reaches the designated number, the present processing ends (step S4: YES). In this way, a set of a command position and a measurement position needed for identification of mechanism data is collected.

The mechanism data calibration unit 134 calculates mechanism data, based on a difference between a command position held by the command position acquisition unit 132 and a measurement position measured by the three-dimensional measuring instrument 20. The mechanism data include a DH parameter for representing a relative relationship between adjacent joint axes of a robot. The DH parameter is a parameter in the Denavit Hartenberg method (DH method) used in a relational expression that determines a relationship between an angle of each driving axis of a robot and a tip position of the robot. In the DH method, a coordinate system is set in each joint axis, and a position and a posture of a robot are expressed based on a relationship between coordinate systems of adjacent joint axes. In the DH method, parameters θ, d, a, α, and β are used. A meaning of each parameter is indicated below.
θ: a rotational angle (about a zᵢ-1 axis) from an Xᵢ-1 axis to an xᵢ axis
d: a distance (link length) from an origin of an i-1st coordinate system to an intersection point of the zᵢ-1 axis and the xᵢ axis
a: a distance (distance between joint axes) from an intersection point of the zᵢ-1 axis and the xᵢ axis to an origin of an i-th coordinate system
β: a rotational angle (about the xᵢ axis) from the zᵢ-1 axis to a zᵢ axis
β: a rotational angle (about a yᵢ axis) from the zᵢ-1 axis to the zᵢ axis

The mechanism data include a mechanism error parameter. The mechanism error parameter may include an element that changes a tip position and a posture of a robot, such as an error of the DH parameter (θ, d, a, α, and β), a spring constant (element representing bending of an arm due to gravity or external force) with respect to torque generated in a three-dimensional direction of each driving axis, and an angular transfer error acquired by modeling a relationship between an encoder output and a rotational amount of each axis.

For example, when bending of each axis with respect to torque generated about x, y, and z axes of each axis is corrected, three spring constants may be provided as an error parameter to each axis, and torque×spring constant may be added as a correction amount to θ, α, and β described above.

With regard to an angular transfer error, a model (y=ax) having, as an error parameter, a ratio (a) of a rotational amount (y) to an encoder output (x) or a model (y=ax+b·cos (x)) acquired by formulating a relationship between an encoder output (x) and a rotational amount (y) may be used and added as a correction amount to θ, α, and β described above.

Further, the mechanism data may include an error of a position of an origin of a world coordinate system, and a table of a coordinate value of each axis and an orthogonal coordinate value for spatial correction.

The mechanism data may include a matrix or a relational expression indicating a relative positional relationship between joint portions adjacent to each other in a robot. In this case, the mechanism data may include a homogeneous transformation matrix T that determines a positional relationship between adjacent joint portions determined by the DH parameter described above, and a relational expression acquired by expanding the homogeneous transformation matrix T.

With reference to FIG. 2, a coordinate system 75 indicates a coordinate system in a k-th joint portion. A coordinate system 76 indicates a coordinate system in a (k+1)-th joint portion adjacent to the k-th joint portion. With a homogeneous transformation matrix Tₖ for calculating the (k+1)-th coordinate system from the k-th coordinate system and a homogeneous transformation matrix T_{UT} for calculating a tool coordinate system from a flange coordinate system, a homogeneous transformation matrix Tip for calculating a position Pp of a tool tip point from a first coordinate system can be represented by Equation (1) below.

$${T}_{1 P} = {T}_{1} {T}_{2} … {T}_{n} {T}_{U T} \qquad ( 1 )$$

When the homogeneous transformation matrix in Equation (1) is expanded, a relational expression for calculating the position Pp of the tool tip point from the first coordinate system can be acquired. The homogeneous transformation matrix or the relational expression may include an error for a design value. For example, the mechanism data may be a transformation matrix or a relational expression determined by a parameter (ai+Δai) including an error Δai for a parameter ai of a design value, a parameter (αi+Δαi) including an error Δαi for a parameter αᵢ of a design value, and the like.

The mechanism data calibration unit 134 identifies mechanism data by using a technique such as a least squares method in such a way that an error between a measurement position and a command position is minimum. When a vector having the error parameter described above as an element is q, a vector p indicating a three-dimensional position of a robot tip portion can be represented as follows by a function f in consideration of an error model.

$$p = f ( q )$$

A vector Δp representing a displacement amount of a designated position and a measurement position of the robot tip portion can be approximated as follows by a sum of linear coupling of minute fluctuations of each error parameter. JA is a Jacobian.

$$Δ p = ( \partial p / \partial q ) \cdot Δ q = JA \cdot Δ q$$

Since the three-dimensional measuring instrument acquires a measurement result of a three-dimensional position, three equations hold from one posture measurement. By extending the equations into a plurality of measurement postures, a vector Δr and a Jacobian D indicating a displacement amount corresponding to the measurement postures can be acquired and represented as follows.

$$Δ r = D \cdot Δ q$$

It is general to identify an error parameter by solving a repeated estimation problem in which Δr is minimum.

As described above, the mechanism data calibration unit 134 can calibrate mechanism data in such a way as to reflect an actual error of a position of a robot.

The mechanism data output unit 135 can output the calibrated mechanism data. The mechanism data output unit 135 can output the mechanism data in a file form. An output destination of the mechanism data may be an external device, or may be the storage unit 140 in the calibration device 130. A mechanism data file 90 generated from the mechanism data output unit 135 may be in a different form between the case where it is used for a purpose of causing an error in a virtual robot and the case where it is used for a purpose of correcting an error in an actual robot. Alternatively, the mechanism data file 90 may be in a data form that can be commonly referred by a device used for a purpose of causing an error in a virtual robot and a device used for a purpose of correcting an error in an actual robot, and a content and a use method may be distinguished on a device which reads the mechanism data for correcting an error in the actual robot or the virtual robot.

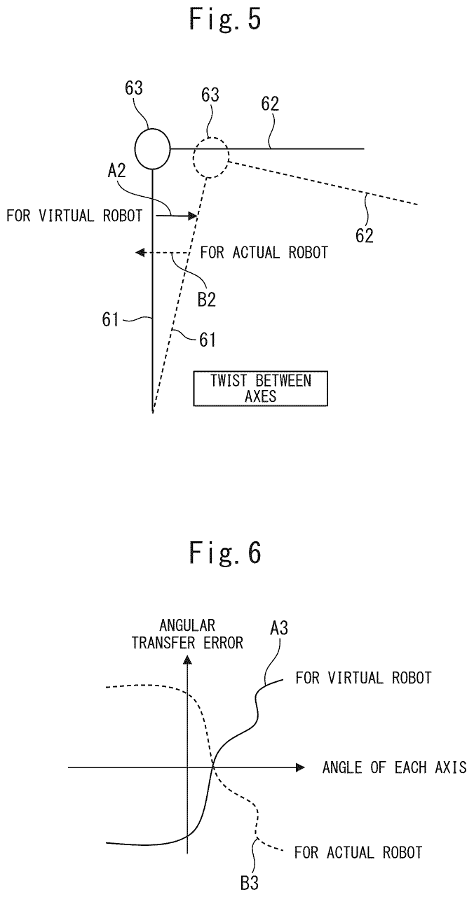

Bending of an arm due to gravity as one element of a mechanism error parameter of mechanism data will be described with reference to FIG. 4. In FIG. 4 (and FIG. 5), a robot includes arms 61 and 62 and a joint portion 63 for simplifying description. The arm 62 is assumed to be bent downward due to an influence of gravity. As illustrated in FIG. 4, when bending due to gravity occurs in the arm 62, the mechanism data calculated as described above by the mechanism data calibration unit 134 reflect an error of the bending. By using the mechanism data (mechanism error parameter), the same bending as the bending due to gravity generated in an actual robot can be generated in the arm 62 of a virtual robot (an arrow A1 in FIG. 4). On the other hand, the mechanism data for the actual robot may be data that apply correction in an opposite direction to an error caused in the virtual robot in such a way that a position and a posture of the robot illustrated in FIG. 4 can be reached even with the bent arm (an arrow B1 in FIG. 4).

A twist between axes as one element of a mechanism error parameter of mechanism data will be described with reference to FIG. 5. As illustrated in FIG. 5, an error due to a twist between axes is assumed to occur in the arm 61. In this case, the mechanism data calculated as described above by the mechanism data calibration unit 134 reflect the twist between the axes. By using the mechanism data (mechanism error parameter), the same twist between axes as the twist between the axes generated in the actual robot can be generated in the arm 61 of the virtual robot (an arrow A2 in FIG. 5). On the other hand, the mechanism data for the actual robot may be data that apply correction in an opposite direction to an error caused in the virtual robot in such a way that a position and a posture indicated by a solid line in FIG. 4 can be reached in the actual robot even with the twist between the axes (an arrow B2 in FIG. 5).

An angular transfer error as one element of a mechanism error parameter of mechanism data will be described with reference to FIG. 6. The mechanism data calculated as described above by the mechanism data calibration unit 134 reflect the angular transfer error. The angular transfer error indicated by the mechanism data is assumed to be a characteristic as in a solid line in FIG. 6. In this case, the angular transfer error occurring in the actual robot is caused in the virtual robot, and thus an angular transfer error A3 as in the solid line in FIG. 6 is provided to the virtual robot. On the other hand, as the mechanism data for the actual robot, data may be generated to provide an angular transfer error B3 as in a characteristic by a broken line being an opposite characteristic from the angular transfer error by the solid line in such a way as to correct an error of a position due to the angular transfer error as in the solid line.

The mechanism data revision unit 136 provides a function of setting revision or non-revision for each element of the mechanism data of the actual robot. Revision may be performed by designating a proportion in which each mechanism error parameter is applied.

It should be noted that, when revision of mechanism data (application of calibrated mechanism data) is not performed on an actual robot, an off-line program created by using a virtual robot to which the mechanism data are applied may be used. When revision of mechanism data (application of calibrated mechanism data) is performed on an actual robot, position data taught before the application can be set achievable again by converting the position data taught before the application and saved in a program and a system (see a second embodiment and a fourth embodiment described below).

As described above, by allowing mechanism data to be calculated by the mechanism data calibration unit 134 and be output from the mechanism data output unit 135, an error of an actual robot can be reflected in a virtual robot by using the mechanism data in the off-line teaching device 50. As a result, creation and conversion of a program can be performed by using the virtual robot including the error.

Furthermore, with the mechanism data correction unit 136, a proportion in which the mechanism data are applied to the actual robot can be selected according to a creation method and a conversion method of a program off-line. As a result, calibrated mechanism data can also be applied to a robot in an optimum manner, for example, in such a way that whether the mechanism data are applied or are not applied to the actual robot is determined or the mechanism data are applied to an extent that revision of the data taught before the application of the mechanical data is unnecessary, by considering the number of pieces of position data taught before the application of the mechanism data and the like.

By using the mechanism data (calibrated mechanism data) output from the calibration device 130, the off-line teaching device 50 can cause a virtual robot to reach an appropriate position in which the mechanism data are reflected. In this way, the off-line teaching device 50 can perform accurate teaching (off-line programming).

Particularly, in the embodiment, the mechanism data (mechanism error parameter) may include (a) an element that cannot be reflected in a CAD model in a detailed and accurate manner by data acquisition by a measurement, such as a link length and an assembly error of a robot, and (b) an element that cannot be reflected in the CAD model, such as bending due to gravity and an angular transfer error. Therefore, the off-line teaching device 50 can perform detailed and accurate teaching in which the mechanism data including the mechanism error parameter such as (a) and (b) described above are reflected.

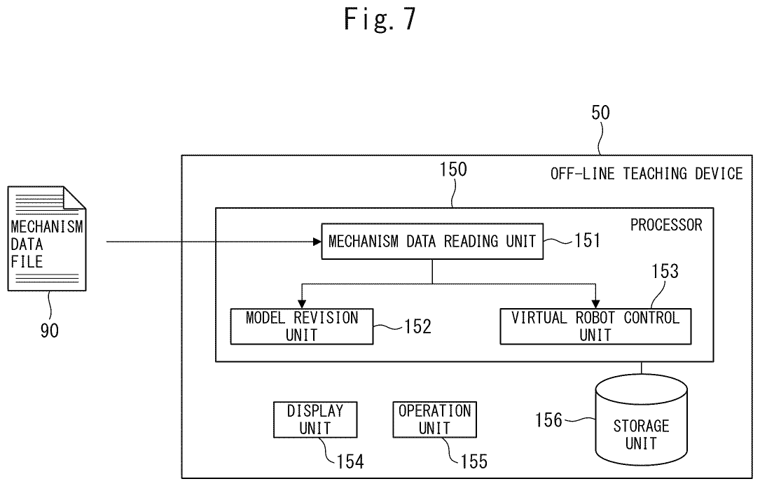

FIG. 7 illustrates a functional block diagram of the off-line teaching device 50. The off-line teaching device 50 may have a configuration as a general computer such as a processor 150, a memory (storage unit 156), a display unit 154, an operation unit 155, and, furthermore, an input/output interface (not illustrated). As illustrated in FIG. 7, the off-line teaching device 50 includes a mechanism data reading unit 151, a model revision unit 152, and a virtual robot control unit 153. It should be noted that the off-line teaching device 50 includes the display unit 154 and the operation unit 155 as a configuration for displaying a user interface (UI) screen related to teaching of a robot, and accepting an operation on the UI screen. The operation unit 155 is a keyboard, a mouse, or a touch panel. In a case of a touch panel, the display unit 154 and the operation unit 155 are integrally formed. The display unit 154 includes, for example, a flat-panel display.

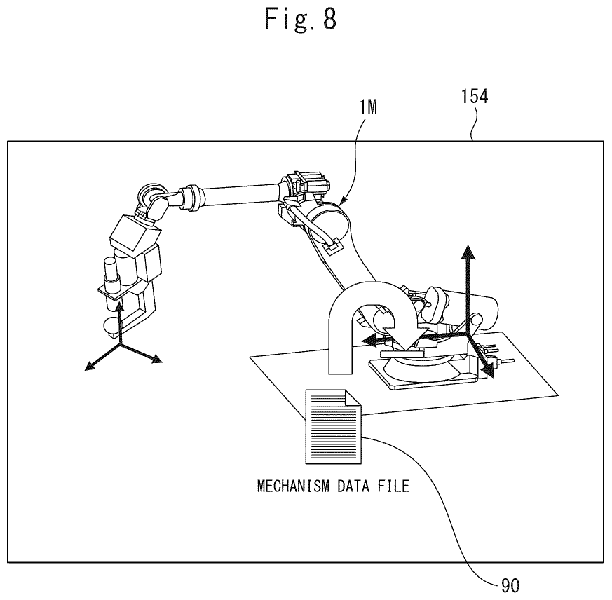

The mechanism data reading unit 151 provides a function of reading and storing the mechanism data file 90. For example, the mechanism data reading unit 151 displays a UI screen as illustrated in FIG. 8 on the display unit 154, and accepts an operation of applying the mechanism data to a virtual robot (i.e., an operation of reading the mechanism data). The UI screen illustrated in FIG. 8 includes a virtual robot model 1M and an image representing the mechanism data file 90. A user drags and drops the mechanism data file 90 onto the virtual robot model 1M via the UI screen, and thus the mechanism data in the mechanism data file 90 are applied to the virtual robot model 1M. The mechanism data reading unit 151 stores the read mechanism data in, for example, the storage unit 156, and also sends the mechanism data to the model revision unit 152 and the virtual robot control unit 153.

The model revision unit 152 revises a CAD model of the virtual robot from information such as a DH parameter of the mechanism data. By using the DH parameter, the model revision unit 152 can reflect a link length, an assembly error, and the like in the CAD model of the virtual robot in a detailed and accurate manner.

The model revision unit 152 may further have a function of revising a CAD model of a workpiece and a peripheral device. In this case, the model revision unit 152 can revise, based on dimensions measured by using the three-dimensional measuring instrument 20, a three-dimensional model of a workpiece and a peripheral device being defined by a variable that can change dimensions.

The virtual robot control unit 153 can calculate a correction amount for correcting a position of a robot, based on the mechanism data. When the virtual robot control unit 153 controls a virtual robot, the virtual robot control unit 153 generates a motion command in such a way as to apply correction in an opposite direction from the calculated correction amount. In this way, the virtual robot can be caused to perform a motion in such a way that an error occurring in an actual robot is reflected in the virtual robot. A specific calculation technique of a correction amount will be described below.

The off-line teaching device 50 is assumed to hold two pieces of mechanism data below. (D1) Mechanism data before update (mechanism data before update by calibration) (D2) Mechanism data after update (mechanism data after update by calibration)

(Procedure K1) Position data in a motion command in the mechanism data (D1) before application are assumed to be each axis position (a). Each axis position (a) is subjected to forward conversion (conversion by forward kinematics) by using the mechanism data (D1) before application, and an orthogonal position p of a robot hand is acquired.

(Procedure K2) Next, the orthogonal position p is subjected to inverse conversion (conversion by inverse kinematics) by using the mechanism data (D2) after application, and each axis position (b) is acquired.

(Procedure K3) (b)-(a) Represents a Correction Amount.

In a case where the “mechanism data (D2) after application” are not applied to an actual robot, a correction amount is added to position data (each axis position (a)) of a motion command in order to convert the position data (each axis position (a)) of the motion command into position data to which the “mechanism data (D2) after application” are applied.

In a case where the “mechanism data (D2) after application” are applied to an actual robot, a correction amount is subtracted from position data (each axis position (a)) of a motion command in order to convert the position data (each axis position (a)) of the motion command into position data to which the “mechanism data (D2) after application” are not applied.

It should be noted that calculation of a correction amount by the procedures described above can also be applied to a case where a robot is replaced.

The virtual robot control unit 153 can generate a motion command in such a way as to apply correction in an opposite direction from a correction amount obtained as described above, and perform control in such a way as to also cause, in a virtual robot, an error occurring in a robot in reality.

In this way, the virtual robot control unit 153 can take, into consideration of calculation of a correction amount, bending due to gravity being changed by a posture of a robot and an angular transfer error, for example, and can introduce the correction amount into control of a virtual robot. In this way, accuracy of interference detection and creation and conversion of a program can be improved regardless of a posture of a robot.

In one cell of an off-line teaching system, for example, the number of robots may exceed 30, and it may take considerable time to perform an operation of selecting a file for each one of the robots and applying mechanism data to a virtual robot. Further, the mechanism data related to bending due to gravity can be reused in a case of the same robot model. In this point, as described above, the mechanism data reading unit adopts a configuration in which the mechanism data can be applied to a robot model by a drag-and-drop operation. In this way, the same mechanism data can be easily applied to a plurality of virtual robots, and time can also be reduced when the mechanism data are applied to a great number of robots.

### Second Embodiment

Hereinafter, a program conversion device 250 according to the second embodiment will be described. The program conversion device 250 provides a function of converting position data of a motion program in such a way that a robot reaches an appropriate position and an appropriate posture in which updated mechanism data are reflected. On the other hand, when updated mechanism data are applied to a robot, there is a possibility that position data taught in a motion program used before the application of the updated mechanism data cannot be used. The program conversion device 250 according to the present embodiment is configured to also provide a function of converting position data of a motion program in such a way that, in a case where updated mechanism data are applied to a robot, a robot reaches the same position as a position when the updated mechanism data are not applied.

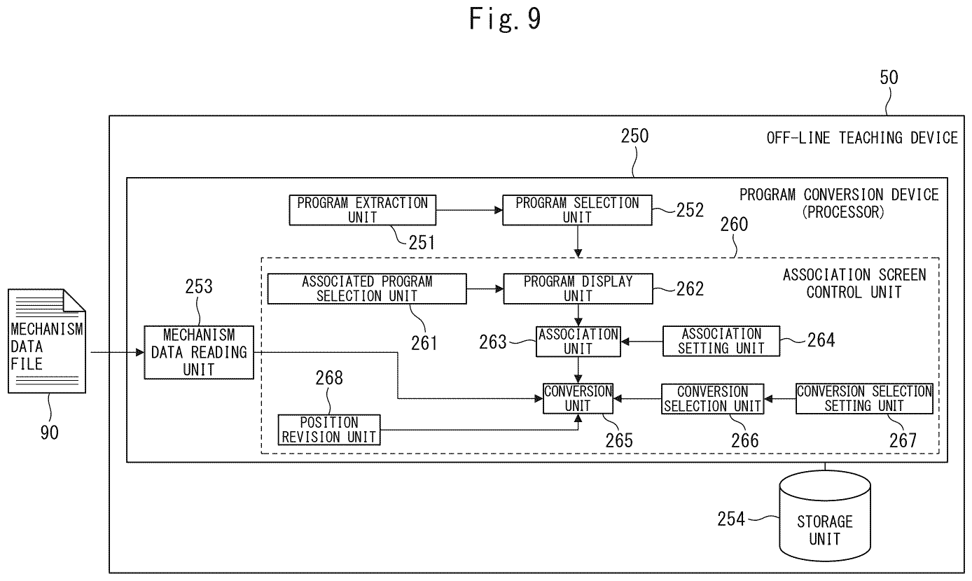

As illustrated in FIG. 9, in the present embodiment, the program conversion device 250 is assumed to be achieved as a function by a processor of an off-line teaching device 50. It should be noted that an example in which the program conversion device 250 is configured as a function achieved by a processor in a robot controller 30 is also possible.

FIG. 9 illustrates a functional block diagram of the program conversion device. The program conversion device 250 includes a program extraction unit 251, a program selection unit 252, a mechanism data reading unit 253, and an association screen control unit 260.

The mechanism data reading unit 253 reads a mechanism data file 90 output from a calibration device 130 (i.e., mechanism data calibrated in an actual robot), and stores the mechanism data file 90 in a storage unit 254.

The program extraction unit 251 extracts programs including calibrated position data about a robot from a list of programs, and lists the extracted programs on a display screen. The program selection unit 252 provides a function of selecting at least one program from the listed programs, based on a user operation. The association screen control unit 260 is called in response to selection of the program via the program selection unit 252.

As illustrated in FIG. 9, the association screen control unit 260 includes an associated program selection unit 261, a program display unit 262, an association unit 263, an association setting unit 264, a conversion unit 265, a conversion selection unit 266, a conversion selection setting unit 267, and a position revision unit 268.

The associated program selection unit 261 lists selected programs on the display screen, and recognizably displays a program in which data needed for conversion of position data are insufficient. For example, the associated program selection unit 261 may change a display color of a program in which data needed for conversion of position data are insufficient, and the like.

The program display unit 262 displays information about a content of the program selected by the associated program selection unit 261, and various types of information provided by the association unit 263 and the association setting unit 264.

The association unit 263 provides functions of estimating and displaying data needed for conversion of the position data, based on a motion program, and allowing a user to revise displayed results. The association setting unit 264 provides a function of setting, in advance, information included in the position data and an estimation method needed for conversion.

The conversion selection unit 266 provides a function of setting conversion/non-conversion for each piece of the position data. The conversion selection setting unit 267 provides a function of setting conversion/non-conversion according to a motion form such as a straight line, each axis, and an arc, or a position form (orthogonal coordinates, each axis) of the position data. The conversion selection unit 266 may be configured to accept a user input for setting conversion/non-conversion for each piece of the position data. The conversion selection unit 266 can decide conversion/non-conversion for each piece of the position data according to setting by the conversion selection setting unit 267. The conversion selection setting unit 267 may be configured to be able to generate setting information according to a user input.

The conversion unit 265 calculates a correction amount, based on updated mechanism data, and adds or subtracts the correction amount to or from the position data. In other words, the conversion unit 265 can provide a function of
(F1) converting, in a case where mechanism data are not applied to an actual robot, position data in a motion program into position data being the same position as a position when the mechanism data are applied to the actual robot, or
(F2) converting, in a case where mechanism data are applied to an actual robot, position data in a motion program into position data being the same position as a position when the mechanism data are not applied to the actual robot. In this case, the proportion of the amount in which the position data are corrected may be settable. The conversion unit 265 may notify a user when the position data cannot be converted. When the position data are set as a relative position, the conversion unit 265 may perform the conversion after changing the relative position to an absolute position and thereafter restore the absolute position to the relative position.

The conversion unit 265 calculates a correction amount applied to the position data as follows, and performs conversion of the position data.

The program conversion device 250 holds mechanism data below.
(D1) Mechanism data before update (mechanism data before update by calibration)
(D2) Mechanism data after update (mechanism data after update by calibration)

The program conversion device 250 calculates a correction amount by (Procedure K1) to (Procedure K3) described in the first embodiment described above.

In order to convert the position data into position data to which the mechanism data (D2) are applied without applying the mechanism data (D2) to an actual robot, the correction amount may be added to each axis position (a).

In order to convert the position data into position data in which the mechanism data (D2) are not applied while applying the mechanism data (D2) to an actual robot, the correction amount described above is subtracted from each axis position (a).

When teaching is performed in an orthogonal form, inverse conversion is performed with the mechanism data (D1), and each axis position (a) is acquired.

In a case of the orthogonal form, each axis position in which the correction amount is added or subtracted is subjected to forward conversion with the mechanism data (D1), and an orthogonal position is acquired.

Application of a correction amount as described above can also be performed when a robot is replaced and mechanism data are updated.

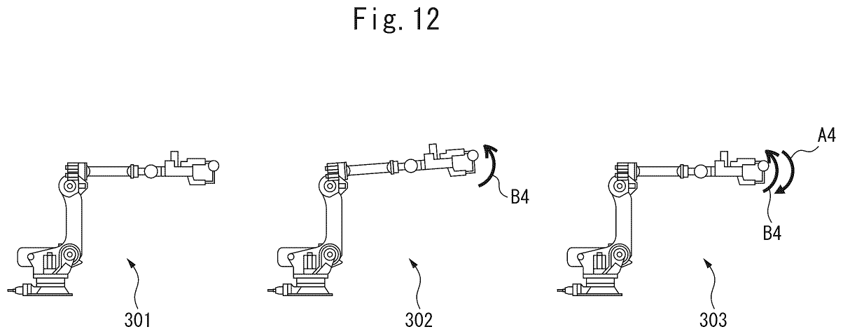

The conversion function described above by the conversion unit 265 can be described with a schematic diagram in FIG. 12. A reference sign 301 is assumed to be a position and a posture (corresponding to each axis position (a) described above) of a robot desired to be reached by off-line programming. An actual robot takes a position and a posture (an arrow A4 provided to the robot indicated by a reference sign 303) being bent more downward than the position and the posture indicated by the reference sign 301. A position and a posture of the robot indicated by a reference sign 302 are assumed to be acquired by adding a correction amount obtained in the conversion processing described above to the position and the posture (each axis position (a)) of the robot indicated by the reference sign 301. Position data about the robot after correction are as indicated by the reference sign 302, but, in the actual robot, due to an influence of bending by gravity, the robot reaches a target position (the position of the robot indicated by the reference sign 301) as indicated by the reference sign 303.

The position revision unit 268 may provide a function of revising the position acquired by the conversion described above on the off-line teaching device 50.

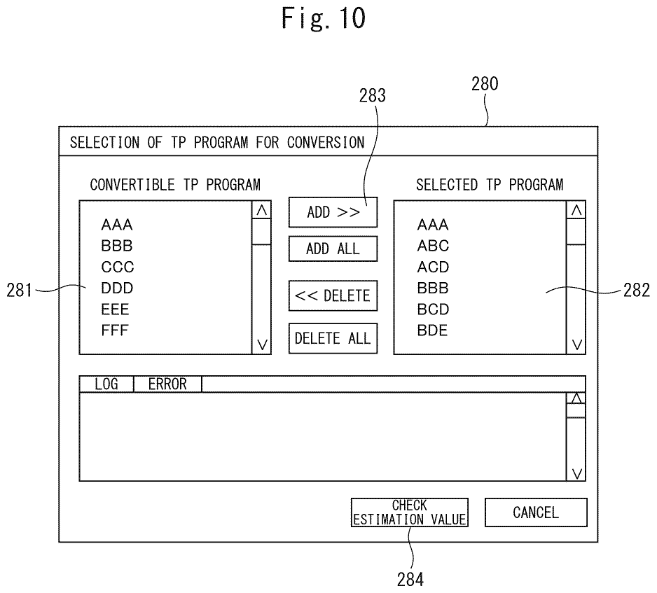

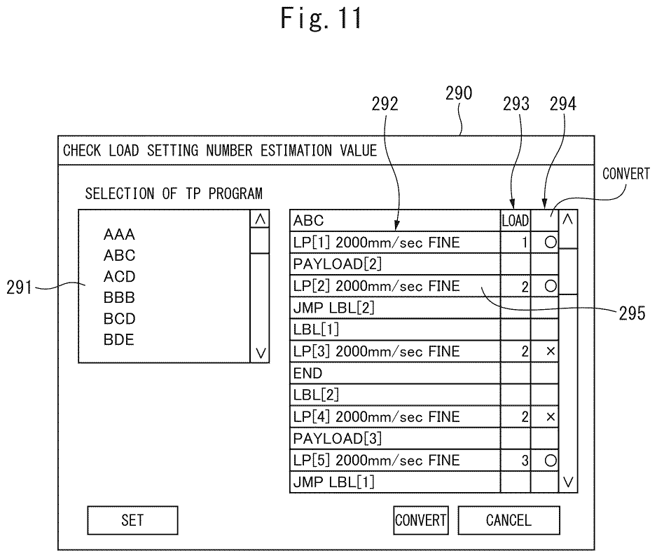

With reference to FIGS. 10 and 11, a user interface (UI) screen provided as a function of the association screen control unit 260 will be described. FIG. 10 is a diagram illustrating a configuration example of a UI screen for selecting a program to be converted. A UI screen 280 illustrated in FIG. 10 is provided as a function by the program extraction unit 251 and the program selection unit 252. The UI screen 280 includes a program list display region 281 for displaying a list of programs extracted by the program extraction unit 251. A user can select a program being a target of conversion from the program list display region 281. For example, the user selects a program in the program list display region 281 and presses an addition button 283, and can thus add the selected program to a conversion target program list display region 282 for displaying a list of programs being a conversion target.

FIG. 11 illustrates a UI screen 290 related to detailed setting of conversion. The UI screen 290 may be activated in response to pressing of a “check estimation value” button 284 in the UI screen 280. In other words, the UI screen 290 also has a function as a screen for checking data estimated by the association unit 263 as necessity for conversion of position data. The UI screen 290 is provided as a function by the association screen control unit 260.

As illustrated in FIG. 11, the UI screen 290 includes a program list display region 291 for selecting a program being a target of processing in the UI screen 290 (a program being a target of association). In the program list display region 291, programs selected in the UI screen 280 and included in the conversion target program list display region 282 are displayed.

The UI screen 290 includes a program display region 292 for displaying contents of a program selected from the program list display region 291. Herein, a program ‘ABC’ is assumed to be selected from the program list display region 291. In the program display region 292, contents of the program ‘ABC’ are displayed.

In the program display region 292, the content of the program ‘ABC’ is indicated for each command sentence.

A column 293 in a row on the right of the program display region 292 is a column for displaying load setting information as an estimation result by the association unit 263 of data needed for conversion. The function provided by the column 293 corresponds to the function of the association unit 263. In the present example, a load setting number as load information is set.

The association unit 263 can estimate load information corresponding to position data, based on a content of a program. For example, the association unit 263 can estimate load information (load setting number) applied to position data from a load setting command (PAYLOAD) included in a program. In this case, the load information applied to the position data can be recognized based on an arrangement position of the load setting command (PAYLOAD). For example, a load setting command located in a position before a command sentence including position data and closest to the command sentence may be estimated as load setting information about the position data.

A user can check load information estimated by the association unit 263 and set in the column 293, and revise the load information as necessary.

With the configuration in which load setting is estimated by the association unit 263 in such a manner and a user can revise the load setting, time and effort of the user for load setting can be eliminated. Further, load information can also be appropriately set for position data in a situation where a plurality of pieces of load setting are present for the position data (for example, a situation where a plurality of pieces of load setting are included in a motion program for one position register).

The association unit 263 may be configured to perform load setting according to setting information by the association setting unit 264. For example, the association setting unit 264 holds, in advance, information indicating a correspondence between a tool coordinate system number included in position data and a load setting number. The association unit 263 can estimate and set a load setting number of each piece of the position data according to the setting information.

In a column 294 further on the right side of the program display region 292, whether to convert position data can be designated for each command sentence including the position data. The function provided by the column 294 corresponds to the function of the association selection unit 266. Herein, whether to perform conversion for each piece of position data included in a program can be set. Therefore, a user can appropriately decide whether to perform conversion according to a characteristic of the position data. For example, when a robot is desired to return to a position before conversion such as a home position, the user can set not to perform conversion on the position.

The association selection unit 266 may be configured to perform automatic setting on whether to perform conversion according to setting information by the conversion selection setting unit 267. For example, the conversion selection setting unit 267 may have setting information that defines “perform/not perform conversion on a specific motion form or position data of a robot”. In this way, setting on conversion (perform conversion/not perform conversion) can be achieved collectively for a specific motion form or position data of a robot. Specifically, a motion in such a way as not to perform conversion since accuracy is not required in a case of each axis motion can be achieved.

The position revision unit 268 can check a converted position, set a position, and reflect the position in position data of a program. For example, when a range of each axis is designated to a reference position and an alarm occurs outside the range, the position may be revised to a position where the alarm does not occur. The position revision unit 268 may be configured to provide a UI screen for revising position data after conversion, and accept an operation of revising the position data.

### Third Embodiment

Hereinafter, a program conversion device 350 according to a third embodiment will be described. When mechanism data are applied to a robot, not only a reached position of the robot but also a trajectory change. The program conversion device 350 has a function of converting position data in a motion program, based on mechanism data, as in the conversion unit 265 according to the second embodiment, and also provides a function of, when a deviation at a certain level or higher occurs between trajectories before and after program conversion as a result of converting the position data, revising the position data in such a way as to reduce the deviation.

In the present embodiment, the program conversion device 350 is assumed to be achieved as a function by a processor of an off-line teaching device 50. It should be noted that an example in which the program conversion device 350 is configured as a function achieved by a processor in a robot controller 30 is also possible.

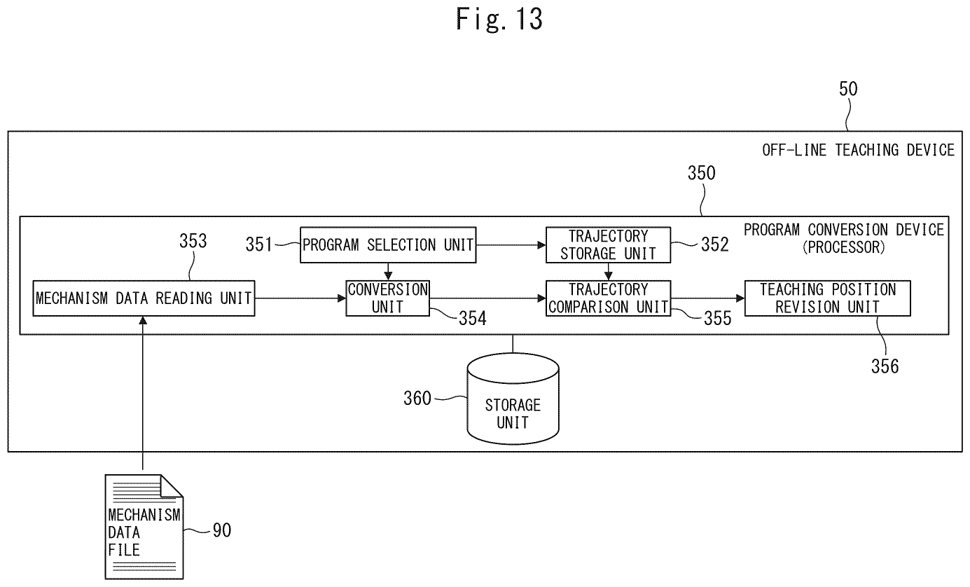

As illustrated in FIG. 13, the program conversion device 350 includes a program selection unit 351, a trajectory storage unit 352, a mechanism data reading unit 353, a conversion unit 354, a trajectory comparison unit 355, and a teaching position revision unit 356.

The program selection unit 351 provides a function of selecting a program being a target of conversion.

The mechanism data reading unit 353 reads a mechanism data file 90 generated and output from a calibration device 130, and stores the mechanism data file 90 in a storage unit 360.

The conversion unit 354 provides a function of revising, by a correction value acquired based on mechanism data, position data in a program selected via the program selection unit 351, and thus performing conversion of the program. It should be noted that the conversion unit 354 is assumed to have the same conversion function as the conversion function by the conversion unit 265 in the second embodiment.

The trajectory storage unit 352 stores
a motion trajectory of a robot based on a motion program selected by the program selection unit 351 (i.e., a motion trajectory before a mechanism error by mechanism data is applied) (hereinafter described as a motion trajectory T1), and
a motion trajectory of a robot based on a motion program after conversion (a motion trajectory after a mechanism error by mechanism data is applied) (hereinafter described as a motion trajectory T2).

The trajectory comparison unit 355 compares motion trajectories of a robot before and after conversion, and determines whether a deviation at a certain level or higher occurs between the motion trajectories. Specifically, the trajectory comparison unit 355 compares a motion trajectory by position data after conversion with the motion trajectory T1 described above when the conversion unit 354 performs conversion by the conversion function (F1) described above. On the other hand, the trajectory comparison unit 355 compares a motion trajectory by position data after conversion with the motion trajectory T2 described above when the conversion unit 354 performs conversion by the conversion function (F2) described above. When a deviation at a certain level or higher occurs in a motion trajectory of a robot before and after conversion, the teaching position revision unit 356 revises at least one piece of position data in a motion program after conversion in such a way as to reduce the deviation.

When mechanism data (mechanism error) are applied to an actual robot, not only position data but also a motion trajectory change. In other words, when mechanism data are applied to an actual robot, and a program is converted in such a way that the robot moves to a target position before the mechanism data are applied, a motion trajectory changes. Then, there is a possibility of occurrence of interference (interference between the robot and a peripheral apparatus and the like) that does not occur before conversion. In this point, according to the present embodiment, a trajectory change before and after conversion can be reduced. In this way, a motion program can be operated in such a way as to reduce a change in a trajectory.

It should be noted that, by regarding trajectory data as time-series data, a trajectory can also be changed (position data can also be revised) in such a way that no change occurs in a motion speed and a motion time of a robot. The function of the configuration described in the present embodiment may be provided as a function of the program conversion device 250 described in the second embodiment.

### Fourth Embodiment

Hereinafter, a position data conversion device 450 according to the fourth embodiment will be described. A case where updated mechanism data are applied to a robot system during production operation is considered. In this case, not only position data in a motion program of a robot but also global position data shared in a system, such as a coordinate system and an origin return position being taught and set in advance, are desired to be subjected to appropriate conversion. The position data conversion device 450 according to the fourth embodiment acquires position data being taught and set in an off-line teaching device 50 or an actual robot (robot controller 30), converts the position data, based on mechanism data, and changes the position data of the off-line teaching device 50 or the actual robot (robot controller 30).

In the present embodiment, the position data conversion device 450 is assumed to be achieved as a function by a processor of the off-line teaching device 50.

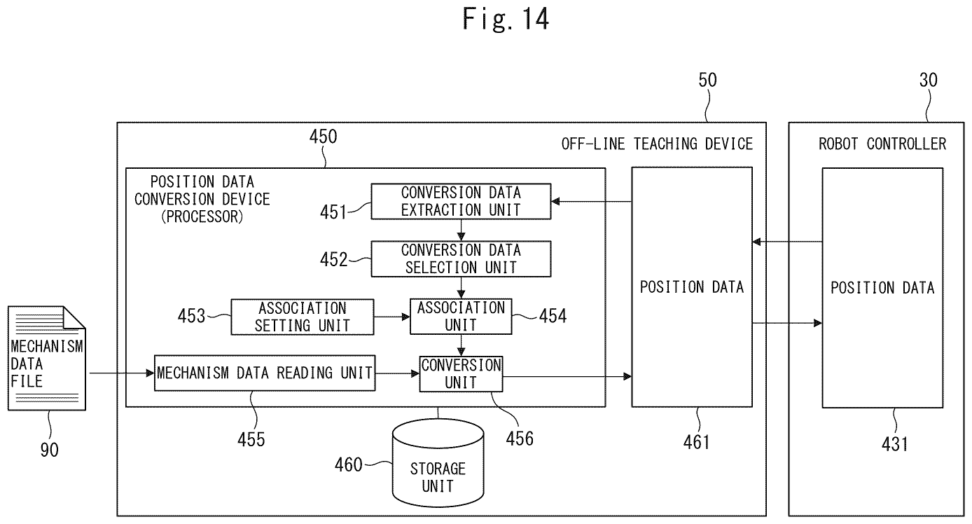

FIG. 14 is a functional block diagram of the off-line teaching device 50 according to the fourth embodiment. The off-line teaching device 50 includes the position data conversion device 450. The off-line teaching device 50 has, in a position data saving unit 461, position data set in a motion program. Further, the robot controller 30 has, in a position data saving unit 431, position data being taught and set with regard to an actual robot. The off-line teaching device 50 acquires position data set in an actual robot from the robot controller 30, and saves the position data in the position data saving unit 461.

The mechanism data reading unit 455 reads a mechanism data file 90 output from a calibration device 130, and stores the mechanism data file 90 in a storage unit 460.

A conversion data extraction unit 451 extracts convertible position data, and provides the position data to a conversion data selection unit 452. The conversion data selection unit 452 selectably displays the extracted position data. The conversion data selection unit 452 may be configured to display a UI screen for selecting position data needed to be converted, and select position data, based on a user operation.

An association unit 454 and an association setting unit 453 respectively have the same function as those of the association unit 263 and the association setting unit 264 in the second embodiment. With the association unit 454 and the association setting unit 453, conversion when data needed for conversion are not included in position data can be efficiently performed.

The conversion unit 456 can convert the selected position data in such a way that, in a case where the mechanism data are applied to an actual robot, the actual robot reaches the same position as a position reached when the mechanism data are not applied.

In a robot during production operation, not only position data in a program but also position data that can be shared in the entire robot system, such as a coordinate system and an origin return position being taught and set in advance, are present. When the off-line teaching system according to the present embodiment is applied to a robot during production operation, and mechanism data are applied to an actual robot during production operation, position data used for the entire system can be converted into a position before application. The function of the configuration (such as the conversion unit 456) described in the present embodiment may be provided as a function of the program conversion device 250 described in the second embodiment.

### Fifth Embodiment

Hereinafter, a program conversion device 550 according to a fifth embodiment will be described. In a tracking motion of following a workpiece moved by a conveyor and the like, position teaching is performed on a coordinate system moving with the workpiece. The program conversion device 550 according to the fifth embodiment provides a function of converting position data in a dynamic coordinate system used for tracking, based on mechanism data.

In the present embodiment, the program conversion device 550 is assumed to be achieved as a function by a processor of an off-line teaching device 50. It should be noted that an example in which the program conversion device 550 is configured as a function achieved by a processor in a robot controller 30 is also possible.

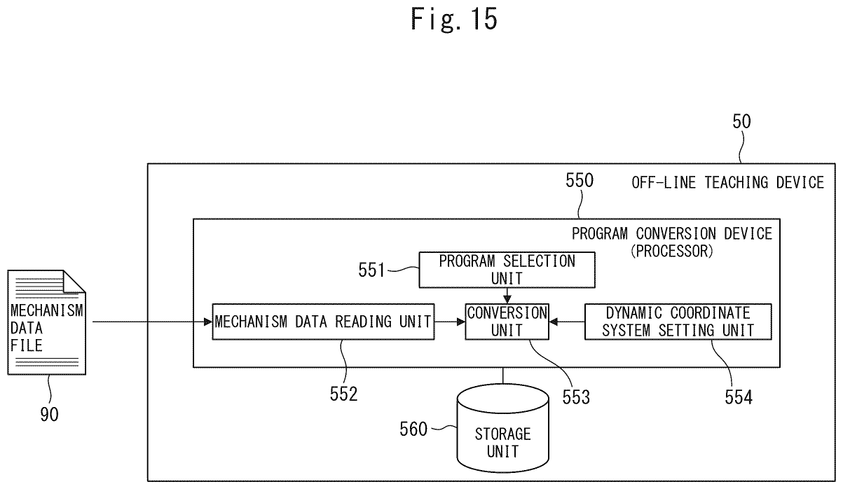

FIG. 15 is a functional block diagram of the program conversion device 550 according to the fifth embodiment. As illustrated in FIG. 15, the program conversion device 550 includes a program selection unit 551, a mechanism data reading unit 552, a conversion unit 553, and a dynamic coordinate system setting unit 554.

The program selection unit 551 provides a function of selecting a program being a target of conversion.

The mechanism data reading unit 551 reads mechanism data generated and output from a calibration device 130, and stores the mechanism data in a storage unit 560.

The dynamic coordinate system setting unit 554 provides a function of setting a movement of a coordinate system dynamically moving. The dynamic coordinate system setting unit 554 sets a movement of the dynamic coordinate system, based on, for example, a user input. The dynamic coordinate system setting unit 554 may acquire information about a movement of the dynamic coordinate system from an external device (for example, a robot controller).

The conversion unit 553 provides a function of revising, by a correction value acquired based on mechanism data, position data in a motion program selected via the program selection unit 551, and thus performing conversion of the program. It should be noted that the conversion unit 553 has the same conversion function as the conversion function of the conversion unit 265 in the second embodiment. When selected position data in a motion program are relative position data with respect to a dynamic coordinate system, the conversion unit 553 performs processing of converting a relative position into an absolute position, converting position data converted into the absolute position, based on mechanism data, by processing similarly to the conversion unit 265 in the second embodiment, and restoring the absolute position to the relative position again.

In the tracking motion, dynamic coordinates are obtained based on an external signal, and a dynamic coordinate system moves by following a movement of a conveyor or a positioner. The movement of the dynamic coordinate system can be checked with information that designates a start position, a direction, a speed, a shape, and the like, such as, for example, “start from A point and move on conveyor at speed of B mm/see”, as setting information about a motion program. In this way, the dynamic coordinate system associated with position data is known, and thus a program for tracking can also be converted by converting a relative position into an absolute position as described above, then adding a correction amount, and restoring the absolute position to the relative position. The function of the configuration described in the present embodiment may be provided as a function of the program conversion device 250 described in the second embodiment.

### Sixth Embodiment

Hereinafter, an off-line teaching device 50 according to a sixth embodiment will be described. The off-line teaching device 50 according to the sixth embodiment provides
(1) a function of converting position data in a program in such a way that a position and an order in which a robot reaches coincide with teaching position information and teaching order information being set in a workpiece model, and
(2) a function of converting position data in a program into a position reached by the robot before mechanism data are applied.

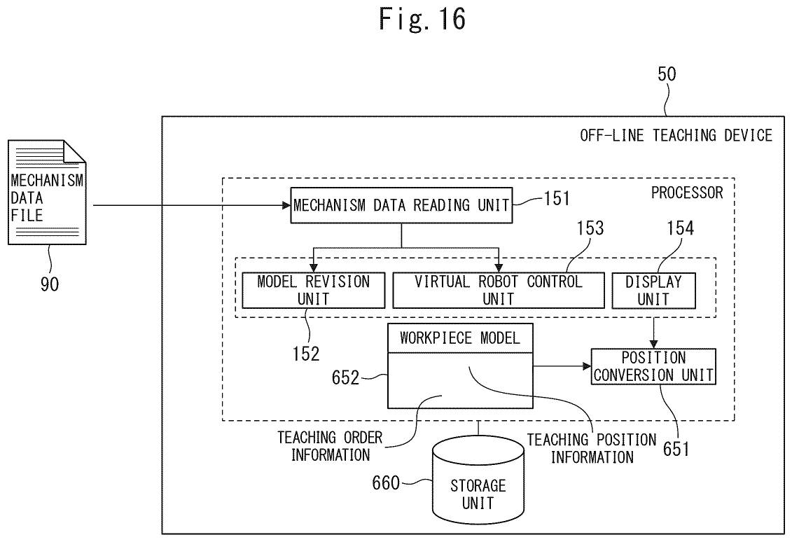

As illustrated in FIG. 16, the off-line teaching device 50 includes a mechanism data reading unit 151, a model revision unit 152, a virtual robot control unit 153, and a position conversion unit 651. It should be noted that FIG. 16 also illustrates a display unit 154 being a component included in the off-line teaching device 50. The off-line teaching device 50 according to the present embodiment includes workpiece model information 652. The workpiece model information 652 includes a workpiece model, teaching position information, and teaching order information.

The mechanism data reading unit 151, the model revision unit 152, and the virtual robot control unit 153 have the function described above in the first embodiment. In other words, the virtual robot control unit 153 provides a function of obtaining a correction value for revising position data, based on a CAD model revised by the model revision unit 152 and mechanism data.

The display unit 154 displays an image representing a motion (simulation motion) during teaching of a robot model, a workpiece model, and other various models.

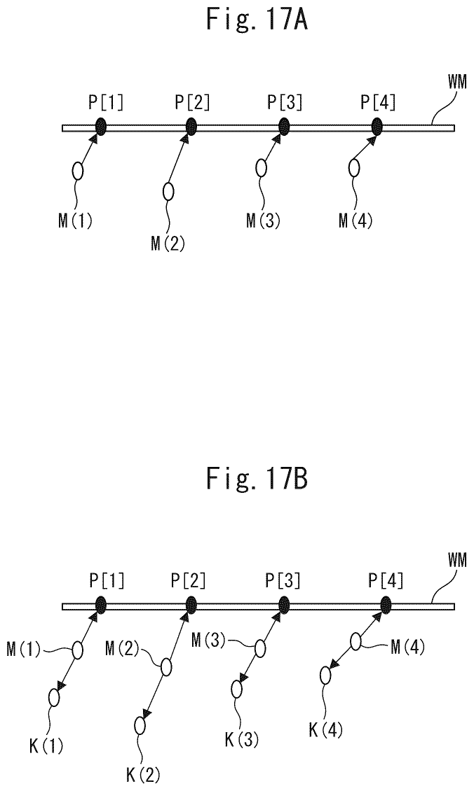

FIG. 17A is a diagram illustrating the function (1) described above (function of converting position data in a program in such a way that a position and an order in which a robot reaches coincide with teaching position information and teaching order information being set in a workpiece model). FIG. 17A illustrates an example of teaching position information and teaching order information included in a workpiece model WM. As illustrated in FIG. 17A, four teaching positions P[1], P[2], P[3], and P[4] are defined in the workpiece model WM. The teaching positions represent an order of P[1], P[2], P[3], and P[4].

FIG. 17A also illustrates reached positions M (1) to M (4) corresponding to the teaching positions P[1] to P[4] after mechanism data are applied to a virtual robot. As a result of applying the mechanism data, the reached positions M (1) to M (4) of the virtual robot do not coincide with the teaching positions P[1] to P[4] designated by the workpiece model. The position conversion unit 651 converts position data in a motion program in such a way that a teaching order and the positions (M (1) to M (4)) reached by the virtual robot coincide with the teaching order and the positions (P [1] to P[4]) included in the workpiece model.

FIG. 17B is a diagram illustrating the function (2) described above (function of converting position data in a program into a position reached by a robot before mechanism data are applied). Similarly to FIG. 17A, the teaching order and the position set in the workpiece model WM are P [1] to P[4], and the reached positions of the virtual robot after application of the mechanism data are M (1) to M (4). The position conversion unit 651 converts the position data in the motion program in such a way that a teaching order and positions reached by the virtual robot are positions K (1) to K (4) having point symmetry with respect to the teaching positions of the workpiece model with the reached positions M (1) to M (4) of the virtual robot as the symmetry center.

When mechanism data are not applied to an actual robot, and position data of a program are changed off-line by the function (1) described above, a program in which the actual robot reaches ideal positions (P [1] to P[4]) suitable for a workpiece model can be constructed.

On the other hand, when mechanism data are applied to an actual robot, and position data of a program are converted off-line by the function (2) described above, a motion program in which the robot reaches positions (M (1) to M (4)) reached by the robot before the mechanism data are applied to the robot can be constructed.

It should be noted that the configuration example in which position data of a motion program are converted according to a teaching order and a position (teaching information) designated by a workpiece model is described above, but conversion of position data may be performed by applying the above-described technique with regard to a program including information (teaching information) about a teaching position and an order instead of a workpiece model. The function of the position conversion unit 651 according to the present embodiment may be provided as a function of the program conversion device 250 described in the second embodiment.

### Seventh Embodiment

Hereinafter, an off-line teaching device 50 according to a seventh embodiment will be described. The off-line teaching device 50 according to the seventh embodiment provides a function of revising a workpiece model in such a way as to reduce a difference between a position reached by a virtual robot and a teaching position designated by the workpiece model.

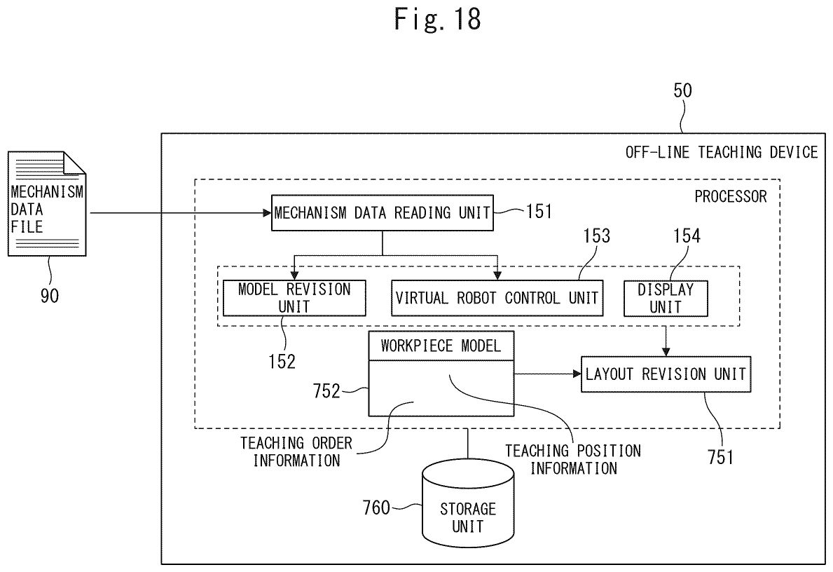

As illustrated in FIG. 18, the off-line teaching device 50 includes a mechanism data reading unit 151, a model revision unit 152, a virtual robot control unit 153, a display unit 154, a layout revision unit 751, and workpiece model information 752.

The mechanism data reading unit 151, the model revision unit 152, and the virtual robot control unit 153 have the function described above in the first embodiment. The workpiece model information 752 includes a workpiece model, teaching position information, and teaching order information.

The display unit 154 displays an image representing a motion (simulation motion) during teaching of a robot model, a workpiece model, and other various models.

The layout revision unit 751 revises a position and a posture of a workpiece model in such a way as to reduce a difference between a position reached by a virtual robot and a teaching position designated by the workpiece model.

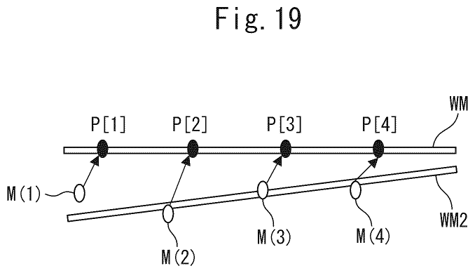

FIG. 19 is a diagram illustrating a motion example of the off-line teaching device 50 according to the present embodiment. A workpiece model WM includes teaching positions and an order of P[1] to P[4]. Positions reached by a virtual robot by applying mechanism data to the virtual robot are assumed to be positions M (1) to M (4). The layout revision unit 752 revises a position and a posture of the workpiece model WM in such a way as to reduce a difference between the positions M (1) to M (4) reached by the virtual robot and the teaching positions P[1] to P[4] included in the workpiece model WM. FIG. 19 illustrates a situation where the positions of the workpiece model WM are revised by the layout revision unit 752 and a revised workpiece model (indicated by a reference sign WM2) mostly coincides with the reached positions M (1) to M (4) of the virtual robot.

According to the present embodiment, a position and a posture of a workpiece and the like can be revised by using a motion program taught according to an actual article (such as the workpiece). A displacement amount of a workpiece can be monitored, and a displacement (a situation of age deterioration) of a robot can be monitored on an assumption that a position of a workpiece is fixed.

### Eighth Embodiment

Hereinafter, an off-line teaching device 50 off-line according to an eighth embodiment will be described. The off-line teaching device 50 provides a function of preventing interference by changing a position of a virtual robot when interference between the virtual robot after mechanism data are applied and a peripheral device and the like occurs.

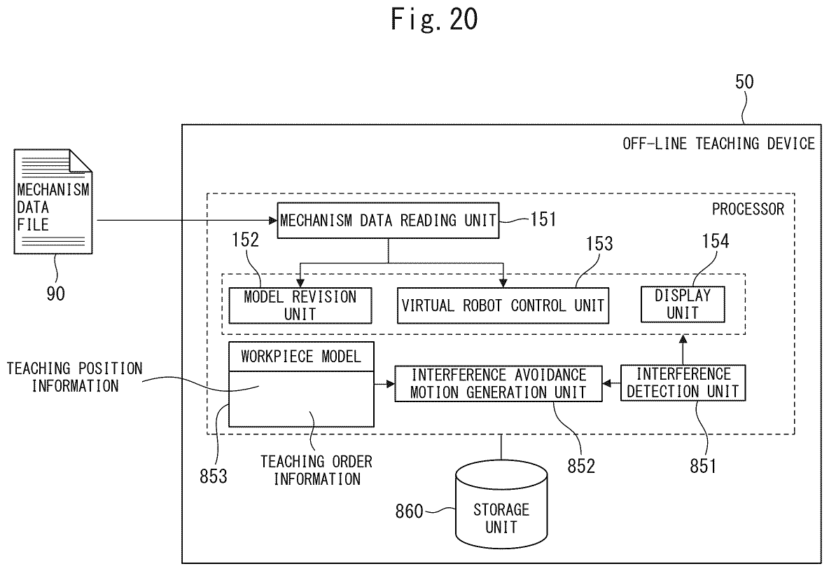

As illustrated in FIG. 20, the off-line teaching device 50 includes a mechanism data reading unit 151, a model revision unit 152, a virtual robot control unit 153, a display unit 154, an interference detection unit 851, an interference avoidance motion generation unit 852, and workpiece model information 853. The mechanism data reading unit 151, the model revision unit 152, and the virtual robot control unit 153 have the function described above in the first embodiment. The workpiece model information 853 includes a workpiece model, teaching position information, and teaching order information.

The interference detection unit 851 detects whether a virtual robot after mechanism data are applied interferes with a peripheral device and the like.

The interference avoidance motion generation unit 852 generates a trajectory based on a motion program in such a way that interference is not detected by the interference detection unit 851 when a virtual robot model is caused to perform a motion based on the motion program, based on teaching position information and a teaching order included in the motion program or the workpiece model information 853.

According to the present embodiment, a virtual robot including an error of an actual robot is used, and thus highly accurate interference detection can be achieved. Particularly, an error when a posture changes during a motion of a robot can also be reflected in a virtual robot, and detection of interference can be more highly accurately achieved.

Although the present disclosure has been described above in detail, the present disclosure is not limited to the individual embodiments described above. Various types of addition, replacement, modification, partial deletion, and the like may be made to the embodiments without departing from the purpose of the present disclosure or without departing from the contents described in the claims and the scope of the present disclosure derived from equivalents thereof. Further, the embodiments can be performed in combination. For example, in the embodiments described above, an order of operations and an order of pieces of processing are indicated as one example, which is not limited thereto. Further, the same also applies to a case where a numerical value or a numerical expression is used in the description of the embodiments described above.

The function of each of the program conversion device described as the second embodiment, the third embodiment, and the fifth embodiment described above and the position data conversion device described as the fourth embodiment may be implemented as an addition to the function of the off-line teaching device 50 described in the first embodiment or as a function in the virtual robot control unit 153.

The program for executing various procedures (such as the collection processing of a command position and a measurement position) in the embodiments described above can be recorded in various computer-readable recording media (for example, a ROM, an EEPROM, a semiconductor memory such as a flash memory, a magnetic recording medium, and an optical disk such as a CD-ROM and a DVD-ROM).

### REFERENCE SIGNS LIST

1 Robot
20 Three-dimensional measuring instrument
30 Robot controller
40 Teach pendant
41 Display unit
42 Input unit
50 Off-line teaching device
90 Mechanism data file
100 Calibration system
130 Calibration device
131 Command generation unit
132 Command position acquisition unit
133 Measurement position acquisition unit
134 Mechanism data calibration unit
135 Mechanism data output unit
136 Mechanism data revision unit
140 Storage unit
150 Processor
151 Mechanism data reading unit
152 Model revision unit
153 Virtual robot control unit
154 Display unit
155 Operation unit
156 Storage unit
250 Program conversion device
251 Program extraction unit
252 Program selection unit
253 Mechanism data reading unit
254 Storage unit
260 Association screen control unit
261 Associated program selection unit
262 Program display unit
263 Association unit
264 Association setting unit
265 Conversion unit
266 Conversion selection unit
267 Conversion selection setting unit
268 Position revision unit
350 Program conversion device
351 Program selection unit
352 Trajectory storage unit
353 Mechanism data reading unit
354 Conversion unit
355 Trajectory comparison unit
356 Teaching position revision unit
360 Storage unit
450 Position conversion device
451 Conversion data extraction unit
452 Conversion data selection unit
453 Association setting unit
454 Association unit
455 Mechanism data reading unit
456 Conversion unit
460 Storage unit
550 Program conversion device
551 Program selection unit
552 Mechanism data reading unit
553 Conversion unit
554 Dynamic coordinate system setting unit
560 Storage unit
651 Position conversion unit
652 Workpiece model information
660 Storage unit
751 Layout revision unit
752 Workpiece model information
760 Storage unit
851 Interference detection unit
852 Interference avoidance motion generation unit
853 Workpiece model information
860 Storage unit

1. A teaching device for performing teaching of a robot, the teaching device comprising:
a storage unit configured to store mechanism data being used for obtaining a relationship between an angle position in a joint portion of a robot and a tip position of the robot and including a mechanism error parameter of an actual robot; and
a virtual robot control unit configured to control a motion of a virtual robot, based on the mechanism data, in such a way that an error of a position occurring in the actual robot by the mechanism error parameter is caused in the virtual robot.

2. The teaching device according to claim 1, wherein
the mechanism data include an element of at least any of a link length and an assembly error of a robot,
the teaching device further comprises a model revision unit configured to revise a three-dimensional model of the virtual robot, based on at least any of the link length and the assembly error of the robot included in the mechanism data, and
the virtual robot control unit performs control of the virtual robot by using the three-dimensional model revised by the model revision unit.

3. The teaching device according to claim 1, further comprising
a mechanism data reading unit configured to display, on a display screen, a three-dimensional model of the virtual robot and an image representing mechanism data stored in the storage unit, accept an operation of dragging and dropping the image representing the mechanism data onto the three-dimensional model of the virtual robot, read the mechanism data in response to the operation, and store the mechanism data in the storage unit.

4. The teaching device according to claim 3, wherein
the mechanism data reading unit displays three-dimensional models of a plurality of virtual robots arranged in one cell, accepts an operation of dragging and dropping an image representing the mechanism data onto one or more three-dimensional models of the plurality of virtual robots, reads the mechanism data in response to the operation, and stores the mechanism data as mechanism data used for the one or more virtual robots in the storage unit.

5. The teaching device according to claim 1, further comprising
a conversion unit configured to convert position data in a motion program in such a way that, in a case where the mechanism data are not applied to an actual robot, the actual robot reaches the same position as a position reached when the mechanism data are applied.

6. The teaching device according to claim 1, further comprising
a conversion unit configured to convert position data in a motion program in such a way that, in a case where the mechanism data are applied to an actual robot, the actual robot reaches the same position as a position reached when the mechanism data are not applied.

7. The teaching device according to claim 5, further comprising
an association unit configured to estimate data needed for conversion of the position data, based on the motion program, and associate the data with the position data for the conversion.

8. The teaching device according to claim 7, further comprising
an association setting unit configured to set setting information used for estimation of the data needed for conversion of the position data.

9. The teaching device according to claim 7, wherein
the data needed for conversion of the position data is load setting information.

10. The teaching device according to claim 5, further comprising
a conversion selection unit configured to select whether to perform conversion on each piece of the position data in the motion program.

11. The teaching device according to claim 10, further comprising
a conversion selection setting unit configured to set setting information used for deciding whether to perform conversion on each piece of the position data.

12. The teaching device according to claim 5, further comprising:
a trajectory comparison unit configured to compare a first motion trajectory of a robot by the position data before conversion by the conversion unit with a second motion trajectory of a robot by position data after conversion by the conversion unit; and
a revision unit configured to, when a deviation at a certain level or higher occurs between the first motion trajectory and the second motion trajectory, revise the second motion trajectory so as to reduce the deviation.

13. The teaching device according to claim 1, further comprising
a conversion unit configured to convert position data including at least any of a taught coordinate system and a taught origin return position and being globally applied in such a way that, in a case where the mechanism data are applied to an actual robot, the actual robot reaches the same position as a position reached when the mechanism data are not applied.

14. The teaching device according to claim 5, further comprising
a dynamic coordinate system setting unit configured to set a movement of a coordinate system dynamically changing, wherein,
when the position data are set as a relative position with respect to a dynamic coordinate system being set in the dynamic coordinate system setting unit, the conversion unit converts the relative position into an absolute position, then performs conversion on the position data, and restores the position data as the converted absolute position to a relative position.

15. The teaching device according to claim 1, wherein
the storage unit stores teaching information including teaching position information and teaching order information, and
the teaching device further comprises a position conversion unit configured to perform conversion in such a way that a teaching position and a teaching order in which the virtual robot reaches coincide with teaching position information and teaching order information being set in the teaching information.

16. The teaching device according to claim 1, wherein
the storage unit stores teaching information including teaching position information and teaching order information, and
the teaching device further comprises a position conversion unit configured to perform conversion on position data in a motion program in such a way that a teaching position reached by the virtual robot is located in a position having point symmetry with respect to a teaching position set in the teaching information with, as the symmetry center, a position in which the virtual robot reaches before conversion.

17. The teaching device according to claim 1, wherein
the storage unit stores a workpiece model, and workpiece model information including teaching position information and teaching order information for the workpiece model, and
the teaching device further comprises a layout revision unit configured to revise a position and a posture of the workpiece model in such a way as to reduce a difference between a position reached by the virtual robot by a motion program and a teaching position of the workpiece model.

18. The teaching device according to claim 1, wherein
the storage unit stores a motion program including teaching position information and teaching order information, and
the teaching device further comprises an interference detection unit configured to change a display state of the virtual robot when interference between the virtual robot and a peripheral device model is detected in a case where the virtual robot is caused to perform a motion based on the motion program.

19. The teaching device according to claim 18, further comprising
an interference avoidance motion generation unit configured to change a motion trajectory by the motion program in such a way that interference does not occur when interference is detected by the interference detection unit.

20. A teaching device for performing teaching of a robot, the teaching device comprising:
a storage unit configured to store mechanism data being used for obtaining a relationship between an angle position in a joint portion of a robot and a tip position of the robot and including a mechanism error parameter of an actual robot, and to store a motion program;
a conversion unit configured to convert position data in the motion program in such a way that, in a case where the mechanism data are not applied to an actual robot, the actual robot reaches the same position as a position reached when the mechanism data are applied, or in such a way that, in a case where the mechanism data are applied to an actual robot, the actual robot reaches the same position as a position reached when the mechanism data are not applied; and
an association unit configured to estimate data needed for conversion of the position data, and associate the data with the position data for the conversion.

21. The teaching device according to claim 20, further comprising
an association setting unit configured to set setting information used for estimation of the data needed for conversion of the position data.

22. The teaching device according to claim 20, wherein
the data needed for conversion of the position data is load setting information.

23. The teaching device according to claim 20, further comprising
a conversion selection unit configured to select whether to perform conversion on each piece of the position data in the motion program.

24. The teaching device according to claim 23, further comprising
a conversion selection setting unit configured to set setting information used for deciding whether to perform conversion on each piece of the position data.

25. The teaching device according to claim 20, further comprising:
a trajectory comparison unit configured to compare a first motion trajectory of a robot by the position data before conversion by the conversion unit with a second motion trajectory of a robot by position data after conversion by the conversion unit; and
a revision unit configured to, when a deviation at a certain level or higher occurs between the first motion trajectory and the second motion trajectory, revise the second motion trajectory so as to reduce the deviation.

26. The teaching device according to claim 20, further comprising
a position data conversion unit configured to convert position data including at least any of a taught coordinate system and a taught origin return position and being globally applied in such a way that, in a case where the mechanism data are applied to an actual robot, the actual robot reaches the same position as a position reached when the mechanism data are not applied.

27. The teaching device according to claim 20, further comprising
a dynamic coordinate system setting unit configured to set a movement of a coordinate system dynamically changing, wherein,
when the position data are set as a relative position with respect to a dynamic coordinate system being set in the dynamic coordinate system setting unit, the conversion unit converts the relative position into an absolute position, then performs conversion on the position data, and restores the position data as the converted absolute position to a relative position.

28. The teaching device according to claim 20, wherein
the storage unit stores teaching information including teaching position information and teaching order information, and
the teaching device further comprises a position conversion unit configured to perform conversion in such a way that a teaching position and a teaching order in which the virtual robot reaches coincide with teaching position information and teaching order information being set in the teaching information.

29. The teaching device according to claim 20, wherein
the storage unit stores teaching information including teaching position information and teaching order information, and
the teaching device further comprises a position conversion unit configured to perform conversion on position data in a motion program in such a way that a teaching position reached by the virtual robot is located in a position having point symmetry with respect to a teaching position set in the teaching information with, as the symmetry center, a position in which the virtual robot reaches before conversion.
